(19) United States
(12) Patent Application Publication
(10) Pub. No.: US 2007/0142147 A1
(43) Pub. Date: Jun. 21, 2007

(54) DISENGAGEABLE BELT DRIVE ASSEMBLIES FOR PAVEMENT SAWS

(75) Inventors: Ken Thornton, BOISE, ID (US); Nathaniel Cody Bateman, BOISE, ID (US)

Correspondence Address: DYKAS, SHAVER & NIPPER, LLP, P.O. BOX 877, BOISE, ID, 83701-0877, US

(73) Assignee: Multiquip, Inc., Carson, CA (US)

(21) Appl. No.: 11/556,060

(22) Filed: Nov. 2, 2006

Related U.S. Application Data
(60) Provisional application No. 60/733,671, filed on Nov. 3, 2005.

(51) Int. Cl. F16H 7/14

(52) U.S. Cl. 474/117; 474/115; 474/114

(57) ABSTRACT

A clutchless belt drive system for pavement saw. The saw having an engine mounted to a frame via a pivot mount. The engine drives a first pulley, which is fixed relative to the engine. The first pulley drives a belt, which in turn drives a second pulley. The second pulley drives a saw blade. An actuator connected to the frame and to the engine so that the actuator extension rotates the engine in a first direction about the pivot mount, driving the first pulley against the belt and tautening the belt about the first pulley and the second pulley, and so that actuator retraction rotates the engine in a second direction counter to the first direction, releasing the first pulley from the belt and relaxing belt tension. A shroud encircles the belt in a plane perpendicular to the line defined by the center of the first pulley and the center of the second pulley. The shroud is positioned so that when the belt tension is relaxed, the belt contacts the shroud and the resulting friction decelerates the belt.

### CROSS-REFERENCE TO RELATED APPLICATIONS

This application claims the priority date of the provisional application entitled DISENGAGEABLE BELT DRIVE ASSEMBLIES FOR PAVEMENT SAWS filed by Ken Thornton, et al., on Nov. 3, 2005 with application serial number 60/733,671.

### FIELD OF THE INVENTION

The present invention generally relates to belt drives and, in particular, pavement saw belt drives that are capable of being disengaged.

### BACKGROUND OF THE INVENTION

A pavement saw is a device used to cut through a slab of pavement and/or used to cut grooves/slots within pavement surfaces. One type of pavement saw is a “concrete saw” used to cut concrete surfaces. A typical pavement saw has a powerful engine driving a rotary saw blade (part of a saw blade assembly). The engine and saw blade assembly are mounted to a rigid frame supported by a set of wheels. In operation, the pavement saw typically rests directly upon the pavement surface to be cut and the saw blade is configured to descend into the cut location from above.

In such a typical pavement saw, to move the pavement saw to a new location, the saw blade first must be retracted (raised out of) from the cut. After retraction, the exposed, spinning blade presents considerable danger to the saw operator and nearby workers.

It is possible to minimize this danger by turning off the engine to stop the blade, but repeatedly stopping and starting the engine is time consuming and results in wear on the engine. It is further disadvantageous to stop the engine (rather than just stopping the rotation of the bladeshaft drive) because having the engine running allows the pavement saw to be more easily driven (via powered wheel assemblies) and/or moved around the job site, loaded onto a trailer or other vehicle, etc. Accordingly, there is a need for a way to slow and/or stop the rotation of the saw blade without stopping the engine.

### SUMMARY OF THE INVENTION

In one embodiment of the present invention, disengageable belt drive may be used to couple and decouple the engine from the saw blade. In one embodiment of the present invention, a belt encircles a moveable drive pulley and a fixed driven pulley. The circumference of the belt is chosen so that when the drive pulley is in a first position, the belt is taut about the drive pulley and the driven pulley, and when the drive pulley is in a second position, the belt is not taut. A shroud encircles the belt in a plane perpendicular to the line defined by the center of the drive pulley and the center of the driven pulley. The shroud is positioned so that when the belt is not taut, it contacts the shroud and the resulting friction decelerates the belt.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a side view of a first embodiment of the invention, showing the belt drive engaged.

FIG. 2. is a partial, perspective detail view of a second embodiment of the present invention.

FIG. 3 is a partial, side view of a third embodiment of the invention, showing the belt drive disengaged.

FIG. 4 is a partial, second side view of the embodiment of FIG. 3 showing the belt drive engaged.

FIG. 5 is a first side view of a fourth embodiment of the present invention, showing the belt drive disengaged.

FIG. 6 is a second side view of the embodiment of FIG. 5, showing the belt drive engaged.

FIG. 7 is a partial side view of a fifth embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

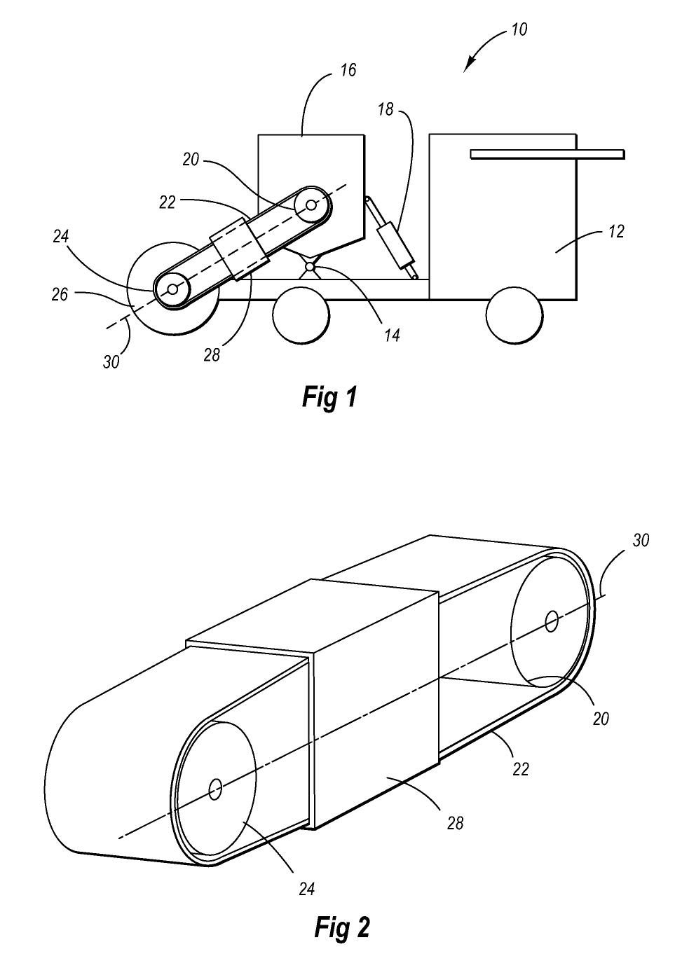

FIGS. 1, 3-7 presents side views of various embodiments of the present invention. For the purposes of illustration, fore and forward refers to the direction toward the left of FIGS. 1, 3-7, and aft and rearward refer to the direction toward the right of FIGS. 1, 3-7. Clockwise and counter-clockwise rotations are made in reference to the view shown in FIGS. 1, 3-7. These directions are for illustration purposes and in no way limit the invention. FIG. 2 showing a close-up (partial perspective) view of one embodiment of the present invention.

A first embodiment is shown in FIG. 1. Referring to FIG. 1, a representative pavement saw 10 (presented in a simple form) has a frame 12 that supports the components of the pavement saw. A pivot mount 14 is rigidly attached to the frame 12. A power source/motor/engine 16 is attached to pivot mount 14 so that engine 16 is free to pivot (preferably fore and aft) relative to frame 12.

While this embodiment of the present invention discloses the use of a rigid pivot mount, obviously other manners of accomplishing this same purpose can be utilized, including but not limited to manipulating, sliding and/or rotating the engine relative towards its placement on the frame. Further, while it is preferred that the engine portion pivot relative to the frame, the pivoting could be accomplished by the second pulley portion pivoting relative to an engine portion fixed relative to the frame, or the engine portion could remain fixed while other portions are moved/pivoted relative to the engine portion, among other ways.

In the embodiment shown in FIG. 1, an actuator 18 connected between frame 12 and engine 16 controls the angle of the pivot of the engine 16 relative to the frame 12. This embodiment's preferred actuator 18 being a hydraulic cylinder. However, for this and other embodiments of the present invention, other actuators and apparatuses are likewise envisioned, including but not limited to mechanical devices, hydraulics, gears, levers, user applied force (manual), gravity, etc. The actuator 18 essentially working as a tension controller, controlling the tension of the belt 22.

In this embodiment, engine 16 drives a first (drive) pulley 20, which in turn drives a belt 22 which drives a second (driven) pulley 24 for driving an attached saw blade 26. The locations of second pulley 24 and saw blade 26 are preferably generally fixed relative to frame 12, whereas the location of the first pulley 20 is not. The first pulley 20 able to move (pivot, slide, rotate, etc.) closer to and/or further from the second pulley 24 in order to add or remove tension from the belt 22. In the preferred embodiment this is accomplished by the first pulley being attached to the engine which in turn is pivotally attached to the frame.

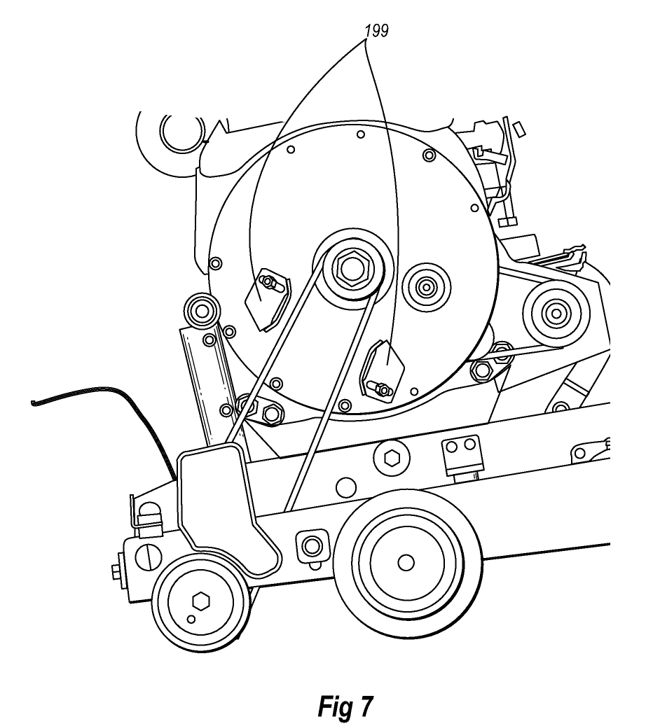

A braking surface or “shroud” 28 is preferably provided which extends adjacent to at least a portion of said belt 22, preferably encircling the belt. FIG. 7 showing an alternate embodiment of a braking surface, namely a pair of opposing, adjustable brake shoes 199. It is further preferred that at least a portion of the braking surface extend preferably in a plane generally perpendicular to a reference axis 30 defined by the geometric centers of pulleys 20 and 24. A perspective view of the shroud 28 is shown in FIG. 2. Shroud 28 need not be perfectly symmetric about axis 30. The shroud 28 and/or braking shoes 199 (FIG. 7) serving to protect the operator from harm as well as providing the necessary braking surface (frictional) for slowing and stopping the rotation of the belt, and thereby the saw blade, when the drive of the saw is disengaged.

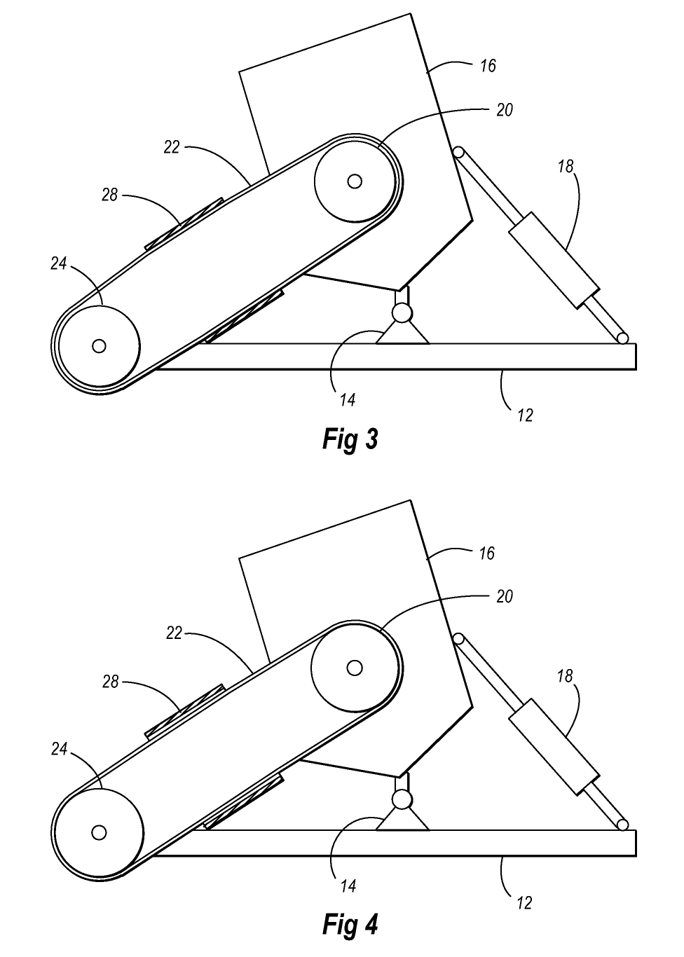

FIGS. 3 and 5 show the disengagement of the belt drive, whereas FIGS. 1, 4, 6 and 7 show the engagement of the belt drive.

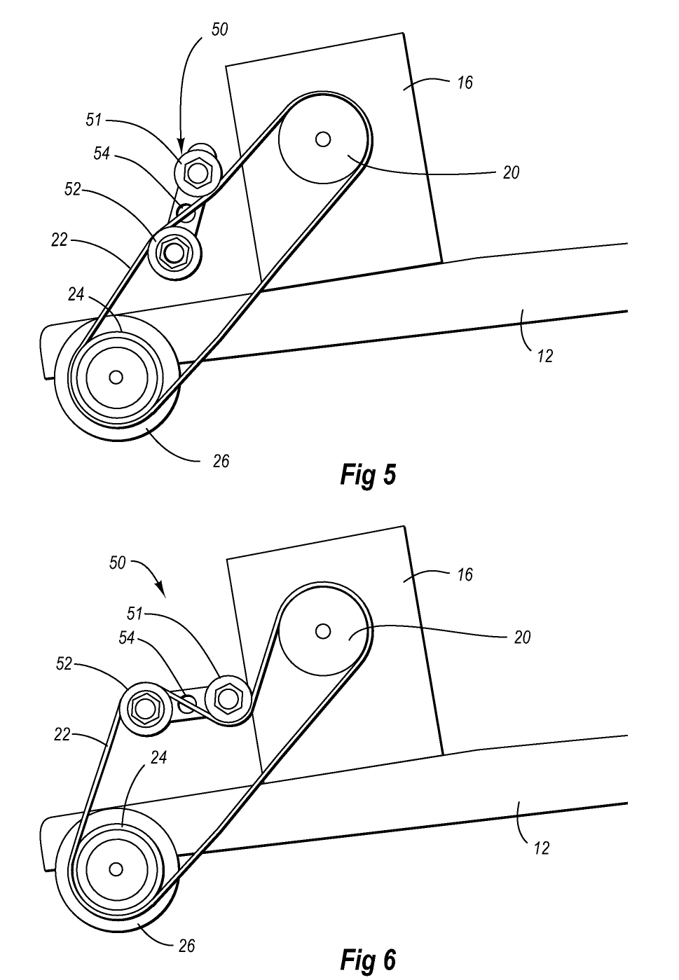

Referring to FIGS. 1 and 4, the actuator 18 is retracted to engage the belt drive, thereby pivoting engine 16 clockwise (relative to the figure) and moving pulley 20 away from pulley 24 until belt 22 is taut there between. When pulley 20 is in this position, belt 22 and pulley 24 are engaged and power is transmitted from engine 16 to saw blade 26.

Referring to FIG. 3, actuator 18 is extended to disengage the belt drive, pivoting the engine 16 counter-clockwise (relative to the figure) and moving pulley 20 toward pulley 24 until pulleys 20 and 24 are generally free of belt tension. When pulley 20 is in a position free of belt tension, the tension of belt 22 is relaxed and centrifugal force drives belt 22 outward where it engages and contacts the inner surface of shroud 28 (or other braking surface). The resulting friction decelerates and ultimately halts the rotation of belt 22. With belt 22 disengaged and halted, pulley 24 and saw blade 26 cease being driven. The tension of belt 22 need not be zero; rather, belt tension must be relaxed sufficient to allow belt 22 to slip on either pulley 20 and/or pulley 24.

A skilled artisan will recognize that any actuator capable of rotating the engine about the pivot mount may also be used as the actuator. In a preferred embodiment, the actuator is a hydraulic cylinder.

In the aforementioned embodiment, the belt drive is engaged by retracting the actuator and disengaged by extending the actuator. However, a skilled artisan will recognize that the components may be modified according to the needs and necessities of a user.

Yet another embodiment is shown in FIGS. 5 and 6. Referring to FIG. 5, a representative pavement saw 10 has a frame 12 that supports the components of the pavement saw. The engine portion 16 fixed relative to the frame 12. In this embodiment, the clutch function is controlled through use of a belt tensioner 50. This belt tensioner comprising a pair of spaced idler pulleys, namely a first idler pulley 51 and a second idler pulley 52. This belt tensioner 50 configured for rotation about a pivot point 54. It is preferred that the spaced idler pulleys be fixed relative to one another.

FIG. 5 showing tension not applied to the belt 22, the drive being thus disengaged. The belt 22 has slack and thus the continual rotation of the drive pulley 20 is not transmitted to the driven pulley 24 and the saw blade 26. However, in FIG. 6, the belt tensioner 50 is rotated, thereby taking up the slack as the belt serpentines through the first and second idler pulleys. In such a configuration, the drive pulley drives the driven pulley and its attached saw blade.

To put it another way, the belt tensioner or “tension controller” 50 controls the tension of the belt. The tension controller 50 comprising a pair of spaced pulleys (51, 52) for receiving the belt 22 there-between. The tension controller 50 configured for rotation in a first direction whereby the spaced pulleys (51, 52) can both engage contact with the belt 22 thereby tensioning the belt 22. The tension controller 50 likewise configured for rotation in a second direction whereby the spaced pulleys (51, 52) can both disengage contact with the belt 22 thereby releasing tension from the belt 22.

The drive pulley 20 need not be directly driven by the engine. In an alternative embodiment, the engine drives the drive pulley through a transmission that rigidly locates pulley relative to the engine and the entire assembly is rotated by the actuator relative to frame. In such an orientation, the engine may or may not physically pivot/move with respect to the frame. In another embodiment, the engine is flexibly coupled to a transmission that rigidly locates pulley relative to the transmission. The actuator is connected to the transmission, and rotates the transmission and pulley relative to the frame. Similarly, the driven pulley 24 need not directly drive the saw blade 26, but may drive the saw blade via a transmission.

Referring now to FIG. 7, shown is an alternative configuration of the present invention. Rather than using the shroud 28 (FIG. 3) or the idler pulleys 51, 52 (FIG. 5), this embodiment utilizes at least one adjustable brake shoe 199. FIG. 7 showing a pair of opposing brake shoes. The brake shoes 199 contact and stop the belt's rotation when in the disengaged position. In the embodiment shown, two shoes opposing one another on each side of the belt are used. These shoes are adjustable so that if different size pulley configurations are used (for different blade shaft speeds, to allow you to run different size blades) the shoes can be adjusted for any pulley configuration.

The exemplary embodiments shown in the figures and described above illustrate but do not limit the invention. Other forms, details, and embodiments may be made and implemented. Hence, the foregoing description should not be construed to limit the scope of the invention, which is defined in the following claims.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A clutchless belt drive system for a pavement saw having a driven saw blade:
a powered pulley rotated by an engine;
a driven pulley connected to said saw blade;
a belt interconnecting said powered pulley to said driven pulley thereby transmitting the rotation of said powered pulley to said driven pulley;
a braking surface for slowing the rotation of the belt and thereby the driven pulley, said braking surface adjacent to said belt and configured for contacting said belt when tension is removed from said belt; and
a tension controller, for controlling the tension of the belt, wherein when tension is applied, the belt drives the driven pulley, and wherein when tension is removed, the belt contacts the braking surface thereby causing the rotation of the belt and driven pulley to gradually stop.

2. A belt drive, comprising:
a fixed first pulley having a first geometric center;
a moveable second pulley having a second geometric center, the second pulley moveable from a first position to a second position;
a belt encircling the first pulley and the second pulley, the circumference of the belt chosen so that when the second pulley is in the first position, the belt is taut about the first pulley and the second pulley, and when the second pulley is in the second position, the belt tension is not taut; and
a braking surface adjacent to at least a portion of said belt in a plane perpendicular to the axis defined by the first geometric center and the second geometric center, the braking surface located so that when the second pulley is in the second position, the belt contacts the braking surface.

3. The belt drive of claim 2, further comprising a controllable actuator having a first mode of operation that places the second pulley in the first position, and a second mode of operation that places the second pulley in the second position.

4. The belt drive of claim 3, wherein the actuator is a hydraulic cylinder.

5. The belt drive of claim 3, further comprising an engine driving the second pulley.

6. The belt drive of claim 5, wherein the actuator moves the engine.

7. The belt drive of claim 5, further comprising a first transmission coupling the engine to the second pulley.

8. The belt drive of claim 7, wherein the actuator moves the first transmission.

9. The belt drive of claim 3, further comprising a saw blade driven by the first pulley.

10. The belt drive of claim 9, further comprising a second transmission coupling the first pulley to the saw blade.

11. A pavement saw, comprising:
a frame;
a saw blade;
a first pulley driving the saw blade and having a first geometric center;
a second pulley having a second geometric center;
a pivot mount affixed to the frame;
an engine driving the second pulley and rotatably mounted to the pivot mount;
a controllable actuator connected to the frame and to the engine, the actuator having a first mode of operation that rotates the engine to a first position, and a second mode of operation that rotates the engine to a second position;
a belt encircling the first pulley and the second pulley and having a circumference chosen so that when the engine is in the first position, the belt is taut about the first pulley and the second pulley, and when the engine is in the second position, the second pulley is released from the belt and belt tension is not taut; and
a braking surface having an inner surface encircling the belt in a plane perpendicular to an axis defined by the first geometric center and the second geometric center, and configured so that when belt tension is not taut, the belt contacts the braking surface.

12. A clutchless belt drive system for a pavement saw having a driven saw blade:
a powered pulley rotated by an engine;
a driven pulley connected to said saw blade;
a belt interconnecting said powered pulley to said driven pulley thereby transmitting the rotation of said powered pulley to said driven pulley; and
a tension controller for controlling the tension of the belt, said tension controller comprising a pair of spaced pulleys for receiving said belt there-between, said tension controller configured for rotation in a first direction whereby said spaced pulleys can both engage contact with said belt thereby tensioning the belt, and said tension controller configured for rotation in a second direction whereby said spaced pulleys can both disengage contact with said belt thereby releasing tension from the belt.
